(19) United States
(12) Patent Application Publication
(10) Pub. No.: US 2002/0043242 A1
(43) Pub. Date: Apr. 18, 2002

(54) Electronic throttle control system and method

(75) Inventors: Shinji Ikeda, Mishima-shi (JP); Katsumi Ishida, Toyoake-shi (JP)

Correspondence Address: OLIFF & BERRIDGE, PLC, P.O. BOX 19928, ALEXANDRIA, VA, 22320, US

(73) Assignee: Toyota Jidosha Kabushiki Kaisha, Toyota-shi (JP)

(21) Appl. No.: 09/972,948

(22) Filed: Oct. 10, 2001

(30) Foreign Application Priority Data
Oct. 16, 2000 (JP) 2000-314685

(51) Int. Cl. F02D 1/00

(52) U.S. Cl. 123/396; 123/399

(57) ABSTRACT

An electronic throttle control system performs open-loop control on a motor of an electronic throttle by pulse width modulation (PWM) control based on a target opening amount TAR set by an accelerator sensor. A microcomputer controls the current output to the motor by periodically controlling an excitation width of an on-pulse with a specified duty ratio. The microcomputer calculates a duty ratio corresponding to the set target opening amount TAR with an accuracy higher than its own resolution. When the calculated duty ratio exceeds a value of the output resolution, the microcomputer adds, e.g., every other cycle, a value having the output resolution to the duty ratio of the on-pulse which is periodically controlled, and averages the current output to the motor.

The disclosure of Japanese Patent Application No. 2000-314685 filed on Oct. 16, 2000 including the specification, drawings and abstract is incorporated herein by reference in its entirety.

### BACKGROUND OF THE INVENTION

1. Field of the Invention

The invention relates to electronic throttle control systems and methods that operates a throttle valve, which opens and closes an intake path of an engine, by a motor.

2. Description of Related Art

Electronic throttle control systems used for automotive engines etc., for example, are known. The electronic throttle controller is equipped with an electronic throttle for opening and closing a link-less type throttle valve provided in an intake path of an engine by an actuator such as a motor, and a controller for controlling this motor. The controller sets a target opening amount of an electronic throttle (throttle valve), for example, based on the operating amount of an accelerator pedal by a driver. By performing feedback control on the motor based on the deviation of an actual opening amount of the throttle valve detected by a throttle sensor with respect to the set target opening amount, the controller controls the electronic throttle such that the actual opening amount matches the target opening amount.

Also when there is abnormality with the throttle sensor, the controller, by performing open-loop control on the motor based on the target opening amount set by the driver, controls the electronic throttle such that the opening amount of the throttle valve matches the target opening amount.

Here, the electronic throttle may be provided with an actuator having a characteristic in which a throttle valve opening amount (throttle opening amount) is determined by a value of supplied control current (e.g. a value of a duty ratio of an on-pulse according to Pulse Width Modulation Control (PWM control).

Examples of such actuator are an “electromagnetic rotary actuator” disclosed in Japanese Utility Model Publication No. 62-188677, an “actuator” disclosed in Japanese Patent Publication No. 9-308211, and the like.

With an electronic throttle which uses the “electromagnetic rotary actuator” disclosed in Japanese Utility Model Publication No. 62-188677, for instance, changes in exciting force according to current control (such as duty ratio control) of a coil provided in a stator give a rotating force to a magnetized rotor paired with the stator. This causes rotation of a throttle valve connected to the rotor in the open direction, such that the throttle valve together with the rotor is rotated to and stopped at an angle position determined by the exciting force.

An example of operating characteristics of the electronic throttle described above are shown in FIG. 7. In this case, the throttle opening amount exhibits substantially linear change with respect to the duty ratio within a duty ratio of 20-80%. When the electronic throttle with such characteristics is controlled by the controller, a resolution of the throttle opening amount (opening amount resolution) LTA, as shown in FIG. 8, is determined by output resolution (minimum control unit of duty ratio) LDT which is determined by the performance of a microcomputer used in the controller.

With the conventional electronic throttle mentioned above, there is a limit in setting the opening amount resolution LTA since it is determined by the output resolution LDT of the microcomputer. On the other hand, however, opening amount control with a higher resolution is required to use more recent electronic throttles. Therefore, in order to achieve opening amount control with a higher resolution using an electronic throttle, a sophisticated microcomputer or a throttle body with a non-linear bore as disclosed in Japanese Patent Publication No. 5-296067 is used.

Nevertheless, the sophisticated microcomputer costs more than other microcomputers, thus making the electronic throttle control system more expensive than those currently in use. Also, the throttle body with a non-linear bore requires time and effort in terms of processing, thereby making the electronic throttle control system more expensive than those currently in use. Therefore, it is desired to realize opening amount control with a higher resolution using the present hardware configuration without making particular changes in the microcomputer or throttle body.

### SUMMARY OF THE INVENTION

It is an object of the invention to provide an electronic throttle control system and method which enables opening and closing of an electronic throttle to be controlled with a higher resolution using the present hardware configuration without making a microcomputer more sophisticated or changing a throttle body to have a nonlinear bore.

A first aspect of the invention relates to an electronic throttle control system and method which performs open-loop control on an actuator of an electronic throttle by PWM control based on a target opening amount. The system includes a controller that controls the current output to the actuator by periodically controlling an excitation width of an on-pulse with a specified duty ratio, and averages the current output to the actuator by adding a value having a predetermined output resolution to the duty ratio intermittently with a predetermined regularity, when the excitation width of the on-pulse is periodically controlled.

According to the configuration above, the electronic throttle control system, in order to control an opening amount of the electronic throttle, performs open-loop control on the actuator by PWM control based on a target opening amount. The controller controls the current output to the actuator by periodically controlling an excitation width of an on-pulse with a specified duty ratio. In this case, when the excitation width of the on-pulse is controlled periodically, the controller adds a value having a predetermined output resolution to the duty ratio intermittently with a predetermined regularity, and thus the current output to the actuator is averaged and increased by the amount of the intermittently added value. Therefore, a control resolution of the actuator increases by the amount of increased current output to the actuator.

A second aspect of the invention relates to an electronic throttle control system and method comprising an electronic throttle whose throttle valve opens and closes by an actuator, the actuator having a characteristic of determining an opening amount of the electronic throttle based on the duty ratio by PWM control. Open-loop control is performed on the actuator by PWM control based on a set target opening amount. A controller controls the current output to the actuator by periodically controlling an excitation width of an on-pulse with a specified duty ratio, calculates a duty ratio corresponding to the set target opening amount with an accuracy higher than the output resolution of the controller, and averages the current output to the actuator by intermittently adding, with a predetermined regularity, a value having the output resolution to the on-pulse periodically, when the calculated duty ratio exceeds the output resolution.

According to the configuration above, the electronic throttle control system, in order to control an opening amount of the electronic throttle, performs open-loop control on the actuator by PWM control based on the target opening amount set by the controller. Here, the controller controls the current output to the actuator by periodically controlling an excitation width of an on-pulse with a specified duty ratio. In this case, the duty ratio corresponding to the set target opening amount is calculated with an accuracy higher than the output resolution of the controller. When the resolution of the calculated duty ratio exceeds the output resolution, the controller adds a value having the output resolution to the duty ratio intermittently with a predetermined regularity, and thus the current output to the actuator is averaged and increased by the value added. Therefore, a control resolution of the actuator increases by the amount of increased current output to the actuator, and the electronic throttle is controlled with a resolution that much higher.

### BRIEF DESCRIPTION OF THE DRAWINGS

The invention will be described with reference to the following drawings in which like reference numerals describe like elements and wherein:

FIG. 1 is a schematic block diagram of an electronic throttle control system according to a first embodiment of the invention;

FIG. 2 is a flowchart illustrating the content of a program for control during a failure according to the first embodiment of the invention;

FIG. 3 is a waveform diagram of the on-pulse according to the first embodiment of the invention;

FIG. 4 is a waveform diagram of the on-pulse according to the first embodiment of the invention;

FIG. 5 is a flowchart illustrating the content of a program for control during a failure according to a second embodiment of the invention;

FIG. 6 is a table illustrating the relationship of parameters according to the second embodiment of the invention;

FIG. 7 is a graph illustrating operating characteristics of an electronic throttle; and

FIG. 8 is a graph illustrating the relationship of an opening resolution and an output resolution.

### DETAILED DESCRIPTION OF THE PREFERRED EMBODIMENTS

Hereinafter, a first embodiment of an electronic throttle control system and method according to the invention will be described in detail referring to the drawings.

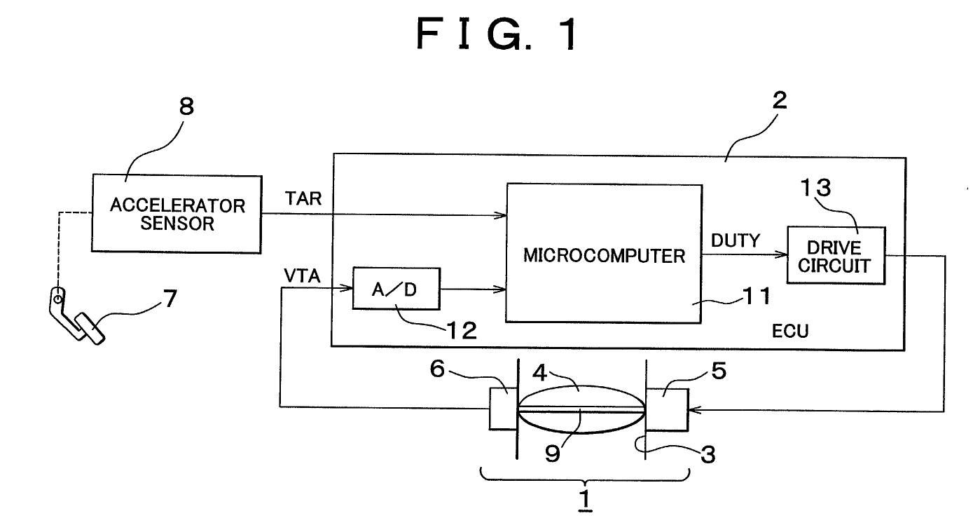

FIG. 1 shows a schematic configuration of the electronic throttle controller. The electronic throttle control system comprises an electronic throttle 1 and an electronic control unit (ECU) 2 for controlling the electronic throttle 1. The electronic throttle 1 adjusts output of an automotive engine (not shown in the drawing), and detects an actual opening amount of a throttle valve 4 with a throttle sensor 6 by opening and closing the throttle valve 4, provided in a bore 3 of a throttle body constituting an intake path of the engine, by a motor 5 which is an actuator. The throttle valve 4 is of link-less type which is not mechanically interlocked with the operation of an accelerator pedal 7. That is to say, the throttle valve 4 opens and closes in response to driving force of the motor 5 controlled by the ECU 2 based on the operating amount of the accelerator pedal 7 which is detected by an accelerator sensor 8.

The throttle valve 4 is rotatably supported by a throttle shaft 9 which extends through the bore 3 of the throttle body. The motor 5 is provided at one end of the throttle shaft 9 and the throttle sensor 6 is provided at the other end thereof. The motor 5 is a torque motor. This motor 5 has a characteristic in which it determines the opening amount of the throttle valve 4 according to a duty ratio by PWM control.

The throttle sensor 6 comprises, for example, a potentiometer. The accelerator sensor 8 detects the operating amount of the accelerator pedal 7 by a driver as a target opening amount TAR in order to set the target opening amount TAR of the throttle valve 4, and thus function to set the target opening amount. This sensor 8 comprises, for example, a potentiometer.

Referring to FIG. 1, the ECU 2 includes a microcomputer 11, an A/D converter 12, and a drive circuit 13. The microcomputer 11 administers control of the electronic throttle 1 and function as a controller. The microcomputer 11 also functions to calculate the duty cycle and determine an average according to the invention. The microcomputer 11 includes, as is generally known, a central processing unit (CPU), random access memory (RAM), read only memory (ROM), and the like. The ROM stores a control program relating to the electronic throttle 1. The A/D converter 12 converts an analog signal output from the throttle sensor 6 into a digital signal, which it outputs to the microcomputer 11. The drive circuit 13 receives the control current output from the microcomputer 11 and outputs a drive current to the motor 5.

In FIG. 1, an analog signal corresponding to an actual opening amount VTA output from the throttle sensor 6 is converted to a digital signal by the A/D converter 12, and that signal is input to the microcomputer 11. An analog signal according to a target opening amount TAR output from the accelerator sensor 8 is directly input to the microcomputer 11.

The microcomputer 11 controls the motor 5 by processing input signals according to the actual opening amount VTA and the target opening amount TAR based on the Proportional Integral Derivative Control (PID control) method. In other words, the microcomputer 11 calculates the opening deviation VER of the actual opening amount VTA with respect to the target opening amount TAR based on a value of each input signal, and calculates a value of a control amount VPID using a predetermined formula based on the value of the opening deviation VER. Then, the microcomputer 11 outputs the drive current corresponding to the value of that control amount VPID to the motor 5 via the drive circuit 13 to control the coil current of the motor 5. Thereby, the driving amount of the motor 5 is controlled to make the actual opening amount VTA of the throttle valve 4 approximate the target opening amount TAR.

On the other hand, if a failure occurs in the throttle sensor 6 for some reason, it would be difficult to perform feedback control on the motor 5 using the actual opening amount VTA detected by the throttle sensor 6. Therefore, with the electronic throttle control system of this embodiment, upon failure of the throttle sensor 6, the control of the electronic throttle 1 during a failure is executed by performing open-loop control on the motor 5 by PWM control based on the target opening amount TAR detected by the accelerator sensor 8.

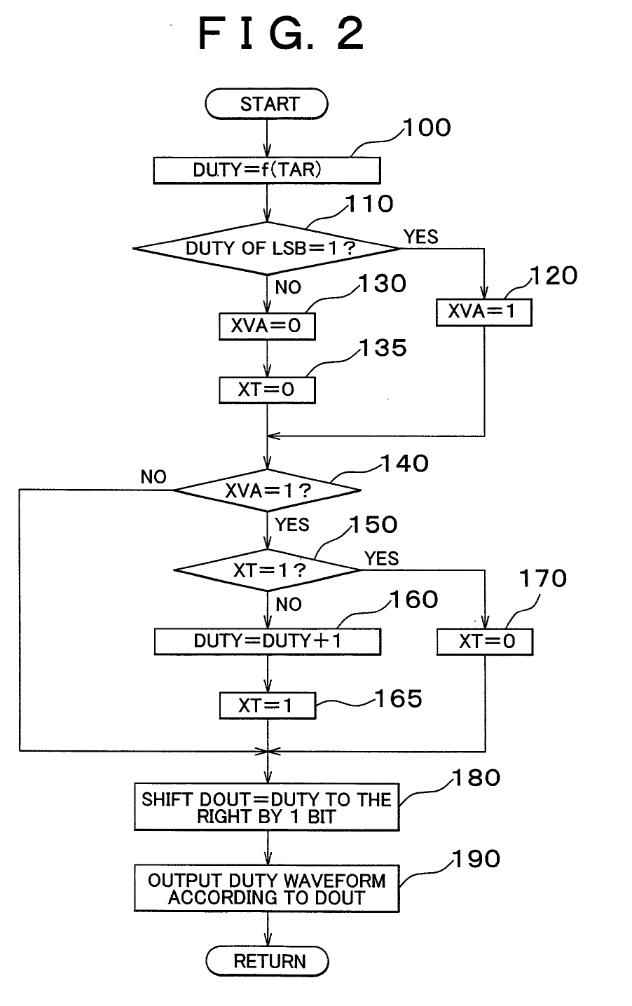

Next, the control during a failure mentioned above will be described below. FIG. 2 is a flowchart illustrating the content of a program for control during a failure executed by the microcomputer 11. The microcomputer 11 periodically executes this routine at predetermined intervals.

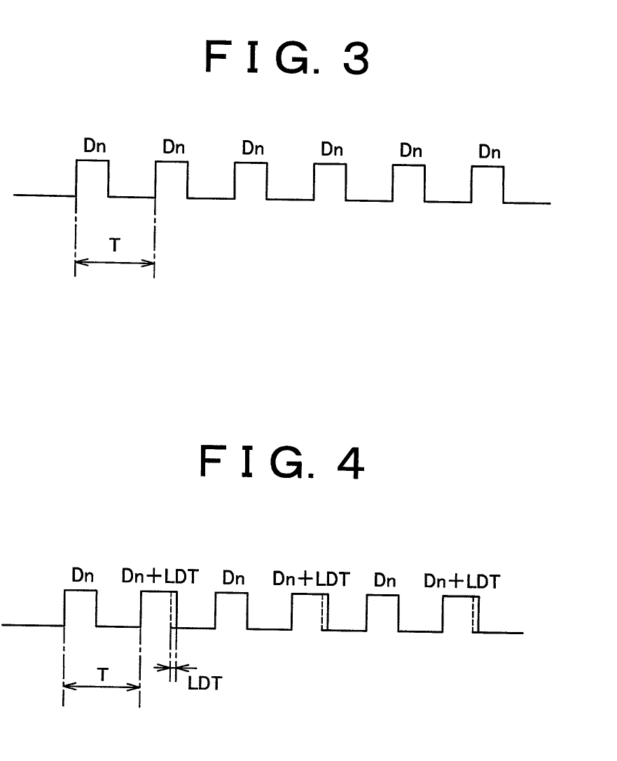

In Step 100, the microcomputer 11 calculates a value of duty ratio DUTY corresponding to a target opening amount TAR detected by the accelerator sensor 8. The duty ratio DUTY, as shown in FIG. 3, refers to the ratio Dn of an excitation width of an on-pulse which is periodically controlled in one cycle T by PWM control. Here, the microcomputer 11 calculates the duty ratio DUTY with an accuracy higher than its own output resolution LDT by 1 LSB (least significant bit).

In Step 110, the microcomputer 11 determines whether or not the least significant bit LSB of a value of the calculated duty ratio DUTY is 1. If the least significant bit LSB is 1, the microcomputer 11 sets, in Step 120, an averaging requirement flag XVA to 1 to increase its own output resolution.

On the other hand, if the least significant bit LSB is not 1, the microcomputer 11 sets the averaging requirement flag XVA to 0 in Step 130, and sets a timing flag XT to 0 in Step 135.

Then, after going through Step 120 or 135, the microcomputer 11 determines in Step 140 whether or not the averaging requirement flag XVA is 1. If the flag XVA is not 1, the microcomputer 11 proceeds to the process in Step 180.

On the other hand, if the averaging requirement flag XVA is 1, averaging of the duty ratio DUTY by PWM control is required, and therefore the microcomputer 11 proceeds to the process in Step 150.

In Step 150, the microcomputer 11 determines whether or not the timing flag XT is 1. If the timing flag XT is not 1, the microcomputer 11 calculates, in Step 160, the duty ratio DUTY by adding only 1 LSB, as the output resolution LDT of the microcomputer 11, to the calculated duty ratio DUTY. Thereafter, in Step 165, the microcomputer 11 sets the timing flag XT to 1 such that the process of Step 160 will not be executed the next time.

However, if the timing flag XT is 1 in Step 150, the microcomputer 11 sets, in Step 170, the timing flag XT to 0 such that the process in Step 160 is executed the next time.

Then, in Step 180, after going through Step 140, 165, or 170, the microcomputer 11 sets a value for which the current calculated duty ratio DUTY is shifted to the right by 1 bit as an output duty ratio DOUT. That is to say, by truncating the lowest bit of the calculated duty ratio DUTY, the accuracy is adjusted to the output resolution LDT of the microcomputer 11.

After that, in Step 190, the microcomputer 11 outputs the control current of duty waveform to the drive circuit 13 according to a value of the set output duty ratio DOUT, and terminates the routine temporarily, after which it is started again.

Therefore, when the averaging requirement flag is not 1 in Step 140, i.e., when averaging of the output is not required, the control current of duty waveform in which the required ratio Dn in one cycle T is the duty ratio DUTY is periodically output to the drive circuit 13 as shown in FIG. 3. On the other hand, when the averaging requirement flag is 1 in Step 140, i.e., when averaging of the output is required, the control current having a waveform in which the required ratio Dn (i.e., on-pulse duration) in one cycle T is the duty ratio DUTY and the output resolution LDT of the microcomputer 11 is added to every other duty ratio Dn is periodically output to the drive circuit 13 as shown in FIG. 4.

For example, in the case of an output duty ratio DOUT with 11-bit accuracy (1 LSB=1 μs, Max. 1 μs×2¹¹=2048 μs (PWM frequency: f=488 Hz)), the duty ratio DUTY is calculated with 12-bit accuracy (1 LSB=0.5 μs, Max. 0.5 μs×2¹²=2048 μs). Here, the fact that the least significant bit LSB of the duty ratio DUTY is 1 means that the fraction of 0.5 μs is required. Therefore, as shown in FIG. 4, adding a value having the output resolution LDT to every other on-pulse having the specified ratio Dn means that the ration-pulse in which 1 LSB is added to the specified ratio Dn is output alternately with the ration-pulse in which 1 LSB is not added to the specified ratio Dn. That is to say, an on-pulse in which 1 μs and 0 μs are added alternately to the required ratio Dn is output periodically, and thus as a whole, this is equivalent to periodically outputting an on-pulse in which an average of 0.5 μs is added.

As stated above, with the electronic throttle control system of this embodiment, in control during a failure, open-loop control is performed on the motor 5 by PWM control based on a target opening amount TAR set by the accelerator sensor 8 in order to control opening of the electronic throttle 1. in this case, the microcomputer 11 controls the current output to the motor 5 via the drive circuit 13 by periodically controlling an excitation width of an on-pulse with the required duty ratio DUTY.

Here, the microcomputer 11 calculates the duty ratio DUTY corresponding to the set target opening amount TAR with an accuracy higher than the output resolution LDT of the microcomputer 11. Then, when the value of the calculated duty ratio DUTY exceeds that of the output resolution LDT, the value of the output resolution LDT of the microcomputer 11 is added to every other required ratio Dn which is the value of the duty ratio DUTY, and thereby the current output to the motor 5 is averaged and increased only by the value added.

Consequently, a control resolution of the motor 5 increases only by the amount of increased current output to the motor 5, and the electronic throttle 1 is controlled with a resolution that much higher. Accordingly, the opening amount of the electronic throttle 1 can be controlled with a higher resolution using the present hardware configuration without making the microcomputer more sophisticated or changing the bore 3 of the throttle body to be non-linear. Particularly, only when the duty ratio DUTY calculated according to the target opening amount TAR exceeds a value of the output resolution LDT of the microcomputer 11, can the opening amount be controlled with a higher resolution according to the requirement of that target opening amount TAR.

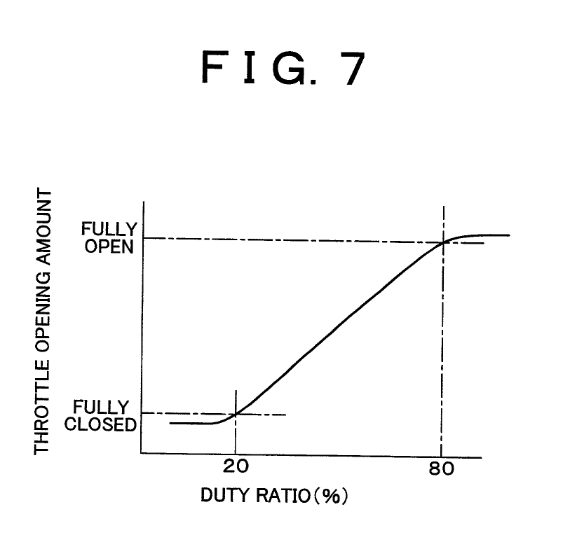

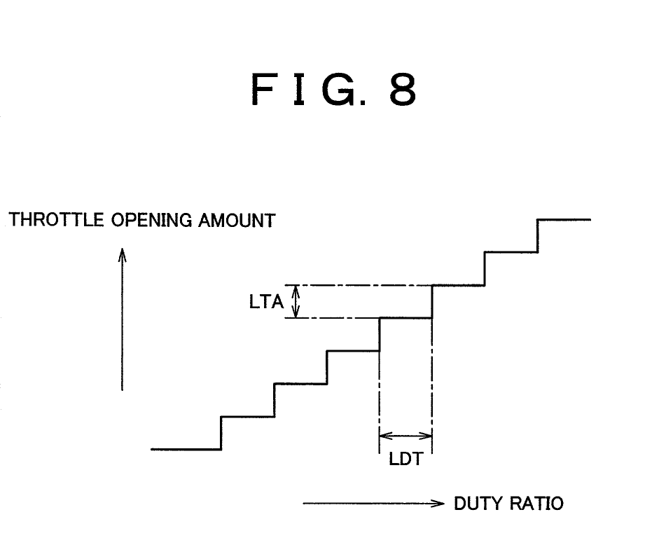

FIG. 7 shows operating characteristics of the electronic throttle 1. Supposing the change in throttle opening amount is 80°, the throttle opening amount would the change linearly with respect to a change in duty ratio of 60%. Therefore, with the change of duty ratio for each 1° being 60/80% and the throttle requirement resolution being 0.05° (equivalent to an engine speed of ten-odd rpms), the duty ratio change for each 0.05° would be:

(60/80)×0.05=0.0375%

When PWM control is executed to control the duty ratio change for each 0.05° by the microcomputer 11, the following output resolution LDT can be obtained with respect to the PWM frequency of 500 Hz.

(1/500)/100%×0.0375%=0.75 μs

Also, with respect to the PWM frequency of 250 Hz, the following output resolution LDT can be obtained.

(1/250)/100%×0.0375%=1.5 μs

At present, the output resolution LDT of the microcomputer generally used in engine control is about 4 μs to 1 μs, which is not sufficient for the required resolution. The requirement of the output resolution LDT is satisfied, however, by reducing the PWM frequency, but a frequency reduced too much could cause problems.

For instance, if the PWM frequency is set to 125 Hz, the output resolution LDT of:

(1/125)/100%×0.0375%=3 μs

can be obtained, but this would cause the motor 5 to follow the current fluctuation by PWM control, thus making the motor 5 susceptible to fluctuation, resulting in a vibration problem occurring in opening and closing of the throttle valve 4.

To solve this problem, as was noted in the description of the conventional example, the throttle requirement resolution may be increased by making the microcomputer 11 more sophisticated or making the bore 3 of the throttle body non-linear. However, such changes in the hardware configuration make the electronic throttle control system expensive.

On the contrary, the electronic throttle control system and method of this embodiment calculates the duty ratio DUTY with an accuracy twice the output resolution LDT of the microcomputer 11. Under PWM control, for the output exceeding the output resolution LDT of the microcomputer 11, an on-pulse in which a value of the output resolution is added to a value of the required duty ratio is output every other output. As a result, it is evident, in view of the average value of the output, that control with twice the resolution can be achieved, and the throttle requirement resolution can be increased without upgrading (making more sophisticated) the microcomputer 11 or changing the bore 3 of the throttle body.

Next, a second embodiment of an electronic throttle control system and method according to the invention will be described referring to the drawings. In this embodiment, the same symbols are used and explanations have been omitted where the configuration is the same as in the first embodiment. The following description therefore focuses on the differences with respect to the first embodiment.

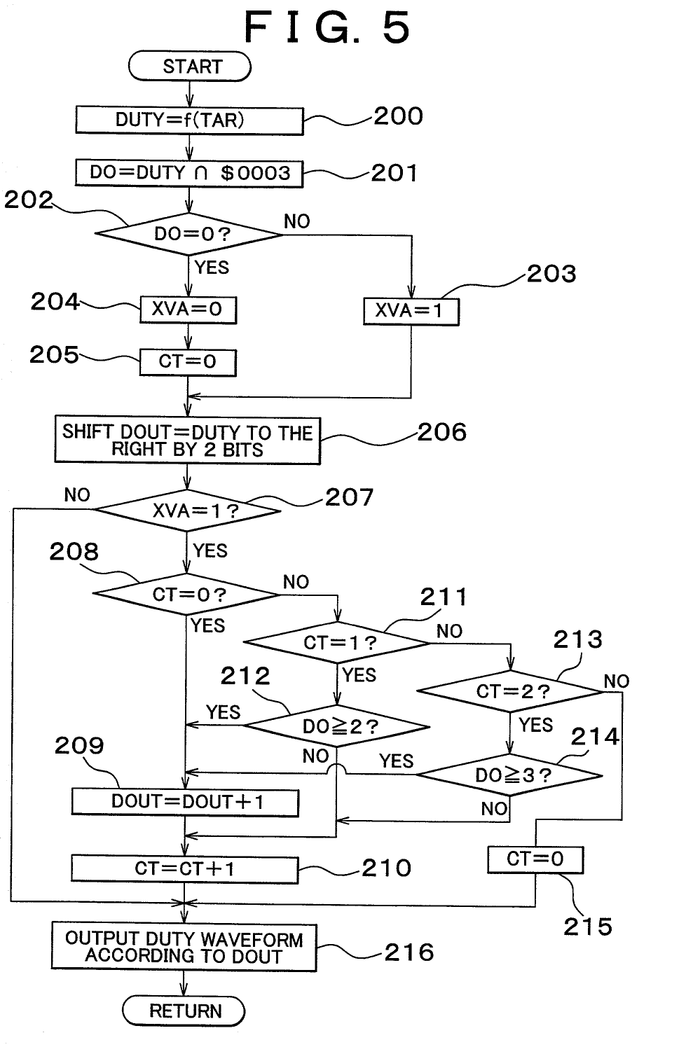

In this embodiment, the configuration of the content of a program for control during a failure differs from that in the first embodiment. The content of the control program is shown in the flowchart of FIG. 5.

In Step 200, the microcomputer 11 calculates a value of the duty ratio DUTY corresponding to a target opening amount TAR detected by the accelerator sensor 8. Here, the microcomputer 11 calculates the duty ratio DUTY with an accuracy higher than the output resolution LTD only by 2 LSB.

In Step 201, the microcomputer 11 substitutes 0 for every bit of the calculated duty ratio DUTY except the lowest two bits. Accordingly, the part of information (fraction) that exceeds the output resolution LDT of the microcomputer 11 is substituted for processing data D0.

In Step 202, the microcomputer 11 determines whether or not the processing data D0 is 0. If the processing data D0 is not 0, i.e., if there is a fraction in the processing data D0, the microcomputer 11 sets the averaging requirement flag XVA to 1 in Step 203 to increase its own output resolution LDT.

On the other hand, if the processing data D0 is 0, i.e., if there is no fraction in the processing data D0, the microcomputer 11 sets the averaging requirement flag XVA to 0 in Step 204 and clears a timing counter CT to 0 in Step 205.

Then, in Step 206, after going through Step 203 or 205, the microcomputer 11 sets a value for which the current calculated duty ratio DUTY is shifted to the right by two bits as the output duty ratio DOUT. That is to say, by truncating the lowest two bits of a value of the current calculated duty ratio DUTY, a value of the duty ratio DUTY in accordance with an accuracy of the output resolution LDT of the microcomputer 11 is substituted for the output duty ratio DOUT.

Thereafter, in step S207, the microcomputer 11 determines whether or not the averaging requirement flag XVA is 1. If the flag XVA is not 1, the microcomputer 11 proceeds to the process in Step 216.

On the other hand, if the averaging requirement flag XVA is 1, averaging of quarterly decomposition process is required for the duty ratio DUTY by PWM control so the microcomputer 11 proceeds to the process in Step 208.

In Step 208, the microcomputer 11 determines whether or not the timing counter CT is 0. If the timing counter CT is 0, the microcomputer 11 calculates, in Step 209, the output duty ratio DOUT by adding 1 LSB, which is a value of the output resolution LDT of the microcomputer 11, to the calculated output duty ratio DOUT.

Then, in Step 210, the microcomputer 11 increases the timing counter CT by 1 and proceeds to the process in Step 216.

On the other hand, if the timing counter CT is not 0 in Step 208, the microcomputer 11 determines whether or not the timing counter CT is 1 in Step 211. If the timing counter CT is 1, the microcomputer 11 proceeds to the process in Step 212.

Then, in Step 212, the microcomputer 11 determines whether or not the processing data D0 is 2 or greater. If the processing data D0 is 2 or greater, i.e., 2 or 3, the microcomputer 11 proceeds to the process in Step 209. However, if the processing data D0 is less than 2, i.e., if it is 1, the microcomputer 11 proceeds to the process in Step 210.

If the timing counter CT is not 1 in Step 211, the microcomputer 11 determines whether or not the timing counter CT is 2 in Step 213. If the timing counter CT is 2, the microcomputer 11 proceeds to the process in Step 214.

In Step 214, the microcomputer 11 determines whether or not the processing data D0 is 3 or greater. If the processing data D0 is 3 or greater, i.e., if it is 3, the microcomputer 11 proceeds to the process in Step 209. On the other hand, if the processing data D0 is less than 3, i.e., 1 or 2, the microcomputer 11 proceeds to the process in Step 210.

Meanwhile, if the timing counter CT is not 2 in Step 213, the microcomputer 11 clears the timing counter CT to 0 in Step 215 and proceeds to the process in Step 216.

Then, in Step 216, after going through Step 207, 210, or 215, the microcomputer 11 outputs a duty waveform to the drive circuit 13 according to a value of the set output duty ratio DOUT and terminates the routine temporarily, after which it is started again.

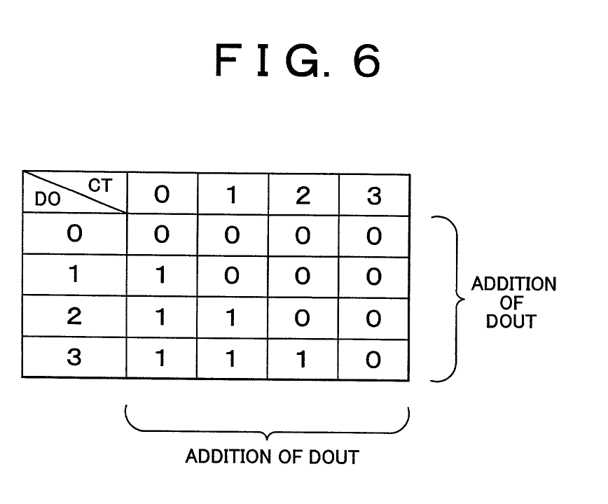

According to the routine above, the relationship of addition of the processing data D0, the timing counter CT, and the output duty ratio DOUT can be obtained as shown in the table of FIG. 6. That is to say, when the processing data D0 is 0 (actually the timing counter CT does not operate when the processing data D0 is 0), 1 is not added to the output duty ratio DOUT at any timing where the timing counter CT is 0 to 3. When the processing data D0 is 1, 1 is added to the output duty ratio DOUT only at a timing where the timing counter CT is 0. When the processing data D0 is 2, 1 is added to the output duty ratio DOUT at a timing where the timing counter CT is 0 or 1.

Furthermore, when the processing data D0 is 3, 1 is added to the output duty ratio DOUT at a timing where the timing counter CT is 0, 1, or 2. When the timing counter CT is 3, 1 is not added to the output duty ratio DOUT in any case where the processing data D0 is 1 to 3.

As stated above, with the electronic throttle control system and method of this embodiment, in control during a failure, open-loop control is performed on the motor 5 by PWM control based on a target opening amount TAR set by the accelerator sensor 8 in order to control the opening amount of the electronic throttle 1. In this case, the microcomputer 11 controls the current output to the motor 5 via the drive circuit 13 by periodically controlling an excitation width of an on-pulse with a required duty ratio DUTY.

Here, the microcomputer 11 calculates the duty ratio DUTY corresponding to the set target opening amount TAR with an accuracy higher than the output resolution LDT of the microcomputer 11 by 2 LSB. Then, by adding a value of the output resolution LDT of the microcomputer 11 to the required ratio Dn, which is a value of the duty ratio DUTY, at a timing according to a difference in values of the processing data D0 representing a fraction in the calculated duty ratio DUTY, the current output to the motor 5 is averaged and increased only by the value added.

Consequently, a control resolution of the motor 5 is increased only by the amount of increased current output to the motor 5, and thus the electronic throttle 1 is controlled with a resolution that much higher. Therefore, the opening amount of the electronic throttle 1 can be controlled with a higher resolution using the present hardware configuration without making the microcomputer 11 more sophisticated or changing the bore 3 of the throttle body to be non-linear.

Also, the invention is not limited to the aforementioned embodiments, but may be modified, such as follows, without departing from the spirit and scope of the invention.

For example, in the first embodiment as shown in FIG. 4, a value of the output resolution LDT of the microcomputer 11 is added to the required ratio Dn, which is the duty ratio DUTY, every other cycle; however, it may be added every two or four cycles.

While the invention has been described with reference to preferred embodiments thereof, it is to be understood that the invention is not limited to the preferred embodiments or constructions. To the contrary, the invention is intended to cover various modifications and equivalent arrangements. In addition, while the various elements of the preferred embodiments are shown in various combinations and configurations, which are exemplary, other combinations and configurations, including more, less or only a single element, are also within the spirit and scope of the invention.

What is claimed is:

1. An electronic throttle control system in which a set target opening amount is set for an electric throttle, comprising:
an actuator for the electronic throttle on which open-loop control is performed by pulse width modulation control based on the set target opening amount; and
a controller that controls a current output to the actuator by periodically controlling an excitation width of an on-pulse with a specified duty ratio, wherein the controller averages the current output to the actuator by intermittently adding, with a predetermined regularity, a value having a predetermined output resolution to the specified duty ratio.

2. The electronic throttle control system according to claim 1, wherein the duty ratio is calculated according to the target opening amount with an accuracy higher than an output resolution of the controller.

3. The electronic throttle control system according to claim 1, wherein the electronic throttle adjusts an output of an automotive engine.

4. The electronic throttle control system according to claim 3, wherein the target opening amount is sets based on an operation amount of an accelerator pedal by a driver of a vehicle containing the automotive engine.

5. The electronic throttle control system according to claim 1, wherein open-loop control is performed on the actuator by the pulse width modulation control when the electronic throttle fails.

6. An electronic throttle control system comprising:
an electronic throttle equipped with a throttle valve;
an actuator that opens and closes the throttle valve to change an opening amount of the electronic throttle according to a duty ratio by pulse width modulation control;
a controller that sets a target opening amount of the electronic throttle, and performs open-loop control on the actuator by the pulse width modulation control based on the set target opening amount, wherein the controller:
(i) controls a current output to the actuator by periodically controlling an excitation width of an on-pulse with a specified duty ratio;
(ii) calculates the specified duty ratio corresponding to the set target opening amount with an accuracy higher than an output resolution of the contoller; and
(iii) averages the current output to the actuator by intermittently adding, with a predetermined regularity, a value having the output resolution to the on-pulse when the calculated specified duty ratio exceeds the output resolution of the controller.

7. The electronic throttle control system according to claim 6, wherein the electronic throttle adjusts an output of an automotive engine.

8. The electronic throttle control system according to claim 7, wherein the controller sets the target opening amount based on an operating amount of an accelerator pedal by a driver of a vehicle containing the automotive engine.

9. The electronic throttle control system according to claim 6, wherein open-loop control is performed on the actuator by the pulse width modulation control when the electronic throttle fails.

10. A method of controlling an electronic throttle comprising:
setting a target opening amount of the electronic throttle;
performing opening-loop pulse width modulation control on an actuator of the electronic throttle based on the set target opening amount;
controlling a current output to the actuator by periodically controlling an excitation width of an on-pulse with a specified duty ratio; and
averaging the current output to the actuator by intermittently adding with a predetermined regularity, a valve having a predetermined output resolution to the specified duty ratio.

11. The method according to claim 10, wherein the specified duty ratio is calculated according to the target opening amount with an accuracy higher than an output resolution of a controller that performs the controlling and averaging steps.

12. The method according to claim 10, wherein the electronic throttle adjusts an output of an automotive engine.

13. The method according to claim 12, wherein the target opening amount is set based on an operation amount of an accelerator pedal by a driver of a vehicle containing the automotive engine.

14. The method according to claim 10, wherein the open-loop control is performed on the actuator by the pulse width modulation control when the electronic throttle fails.

15. A method of controlling an electronic throttle having a throttle valve and an actuator that opens and closes the throttle valve to change an opening amount of the electronic throttle according to a duty ratio by pulse width modulation control, the method comprising:
setting a target opening amount of the electronic throttle;
performing open-loop control on the actuator by periodically controlling an excitation width of an on-pulse with a specified duty ratio;
calculating the specified duty ratio corresponding to the set target opening amount with an accuracy higher than an output resolution of a controller that performs the controlling step; and
averaging the current output to the actuator by intermittently adding, with a predetermined regularity, a value having the output resolution to the on-pulse when the calculated specified duty ratio exceeds the output resolution of the controller.

16. The method according to claim 15, wherein the electronic throttle adjusts an output of an automotive engine.

17. The method according to claim 16, wherein the target opening amount is set based on an operating amount of an accelerator pedal by a driver of a vehicle containing the automotive engine.

18. The method according to claim 15, wherein open-loop control is performed on the actuator by the pulse width modulation control when the electronic throttle fails.
